(19) United States
(12) Patent Application Publication
(10) Pub. No.: US 2022/0404272 A1
(43) Pub. Date: Dec. 22, 2022

(54) AIRBORNE REMOTE SENSING WITH SENSOR ARRAYS

(71) Applicant: Mesos LLC, Houston, TX (US)

(72) Inventors: Robert Kendall, Houston, TX (US); Roelof Jonkman, Mill Valley, CA (US); Samuel Talaber, Houston, TX (US)

(21) Appl. No.: 17/808,092

(22) Filed: Jun. 21, 2022

Related U.S. Application Data
(60) Provisional application No. 63/202,700, filed on Jun. 21, 2021.

(51) Int. Cl. G01N 21/3504; G01M 3/38; B64C 39/02

(52) U.S. Cl. CPC G01N 21/3504; G01M 3/38; B64C 39/024; B64C 2201/127

(57) ABSTRACT

A system for airborne remote sensing comprises an array of remote imaging sensors and supporting equipment configured for a combined larger field of view and provided by any of the array of remote imaging sensors alone. The array is mounted in a housing for attachment to a wing or elsewhere on an aircraft. Data collected by the array may be stitched together to provide an image of a larger area than can be acquired by any one of the remote imaging sensors. The data may be stored onboard the aircraft or transmitted to a ground receiver for analysis. The array of remote imaging sensors thus allows for more effective use of an aircraft for activities such as hydrocarbon leak detection and pipeline right-of-way monitoring.

### CROSS-REFERENCE TO RELATED APPLICATION

This patent application claims priority to U.S. Provisional Patent Application No. 63/202,700, filed on Jun. 21, 2021, and entitled “AIRBORNE REMOTE SENSING WITH SENSOR ARRAYS.” The disclosure of the prior application is considered part of and is incorporated by reference into this patent application.

### TECHNICAL FIELD

The present invention relates to the field of remote sensing, and in particular to a system and technique for airborne remote sensing using camera arrays.

### BACKGROUND ART

A need to reduce methane and other greenhouse gas (GHG) emissions have driven the development of innovative solutions for remote sensing of GHG emissions. Significant efforts have been put into attempts to find cost-effective technologies that could help companies find and manage emissions in a faster, more efficient way. To date, however, leak detection technology has remained slower and more expensive than would be desirable, limiting the ability to find and manage those undesirable emissions.

### SUMMARY OF INVENTION

In one general aspect, a remote sensing system for mounting on an aircraft may include a plurality of remote imaging sensors combined as an array of remote imaging sensors for a combined larger field of view than provided by any one of the plurality of remote imaging sensors. A remote sensing system for mounting on an aircraft may also include a housing, configured for mounting on the aircraft, where the array of remote imaging sensors is disposed within the housing. A remote sensing system for mounting on an aircraft may furthermore include a mounting bracket, configured for attaching the housing to the aircraft.

In a second general aspect, a method of remote sensing may include combining a plurality of remote imaging sensors into an array of remote imaging sensors having a combined field of view larger than any one of the plurality of remote imaging sensors. A method of remote sensing may also include mounting the array of remote imaging sensors in a housing. A method of remote sensing may furthermore include mounting the housing and the array of remote imaging sensors on an aircraft. A method of remote sensing may in addition include flying the aircraft over a predetermined target area. A method of remote sensing may moreover include capturing remote sensing imagery in flight.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a block drawing illustrating a remote sensing aircraft on which is mounted an array of remote imaging sensors according to one embodiment.

FIG. 2 is a block drawing illustrating an array of remote imaging sensors for mounting on a wing of an aircraft according to one embodiment.

FIG. 3 is a block diagram illustrating a housing for mounting an array of remote imaging sensors to an aircraft according to one embodiment.

FIG. 4 is a flowchart illustrating a process for remote sensing according to one embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts are understood to reference all instances of subscripts corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments can implement the features and functionality described herein in software, firmware, or hardware as desired, including any combination of software, firmware, and hardware. References to daemons, drivers, engines, modules, or routines should not be considered as suggesting a limitation of the embodiment to any type of implementation. The actual specialized control hardware or software code used to implement these systems or methods does not limit the implementations. Thus, the operation and behavior of the systems and methods are described herein without reference to specific software code with the understanding that software and hardware can be used to implement the systems and methods based on the description herein

As used herein, satisfying a threshold may, depending on the context, refer to a value being greater than the threshold, greater than or equal to the threshold, less than the threshold, less than or equal to the threshold, equal to the threshold, or the like, depending on the context.

Although particular combinations of features are recited in the claims and disclosed in the specification, these combinations are not intended to limit the disclosure of various implementations. Features may be combined in ways not specifically recited in the claims or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such.

Various types of remote sensing techniques have been used to date. Various parties have used piloted drones, trucks, satellites, airplanes, and combinations of those systems. Drones require a skilled drone pilot to travel from place to place, launch the drone and pilot it in the air, then recover the drone. The data collected by the drone must then be downloaded and analyzed. Because the types of drones used in such a system have significantly limited flight time limitations, the area that can be examined by a drone in a single flight is necessarily also significantly limited. In addition, the cost of hiring a drone pilot and transporting the drone pilot from place to place is significant.

Truck-mounted sensing systems are simpler, typically requiring only a truck driver with sufficient training to operate the truck-mounted sensing equipment. However, the range of truck-mounted sensing equipment is low, the truck is typically limited to areas with good roads, and the time required to drive the truck from site to site can be extensive.

Satellite-based remote sensing systems are highly expensive, with significant infrastructure required to manage the satellite while in orbit. Although satellite remote sensing systems have increased their capabilities since the earliest Landsat satellites were launched in the 1970s, the resolution of remote sensing satellites with a high revisit rate is still larger than desired, while remote sensing satellites with a better resolution rate typically have a prohibitively low revisit rate.

Aircraft flying at low altitudes providing aerial surveillance have been in use for decades and can provide high-resolution sensing capability. However, a single aircraft equipped with a single remote sensing camera can cover a limited area at any time, because of field of view (FOV) limitations. In addition, the cost of the aircraft and skilled pilot are high.

The desired approach is to get high resolution sensing of large areas at the lowest possible cost. In one embodiment, a remote sensing system uses a single plane on which is mounted at least one array of remote imaging sensors, expanding the coverage area at a lower cost than multiple planes, while reducing the time that a single plane with a single remote imaging sensor would need to cover the same area.

The remote sensing aircraft is preferably an aircraft capable of flying low and slow over a predetermined target area. Thus, aircraft of the type used for crop dusting or aerial advertising are a good match for a remote sensing aircraft. The most common agricultural aircraft are fixed-wing aircraft such as the Air Tractor®, the Cessna® Ag-wagon, and the Thrush, but other types of aircraft, such as helicopters, blimps, or other types of airships can also be used. (AIR TRACTOR is a registered trademark of Air Tractor, Inc.; CESSNA is a registered trademark of Textron Aviation, Inc.; THRUSH is a registered trademark of Thrush Aircraft, Inc.) Most such aircraft have piston or turboprop engines, although jet engines could be used. The same or similar type of aircraft is used for aerial advertising and an aerial advertising aircraft could be used for remote sensing operations. Another category of aircraft that can be used for the purpose because of their above-average glide ratio and fuel efficiency is the category of light sport aircraft, such as from Pipistrel d.o.o Ajdo\check{v}čina.

The remote sensing aircraft is configured by mounting one or more remote imaging sensors, typically mounted in an array on one or both wings of the aircraft. However, in some embodiments, the remote imaging sensors are mounted on the fuselage of the aircraft, on the undercarriage, or in the fuselage aimed through an aperture in the cockpit or other desired portion of the fuselage. The remote imaging sensors are mounted so that multiple sensors can gather data simultaneously over the same location.

Preferably, multiple remote imaging sensors are located vertically or on a gyroscope so that they always capture nadir imagery directly below the aircraft at a given overlap from the previous image, to allow properly stitching the data together into a continuous remote sensing record.

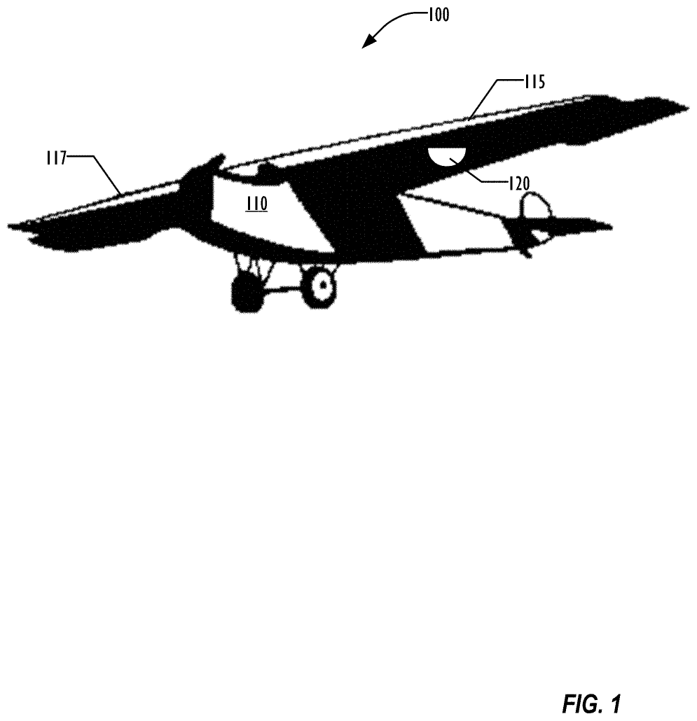

Any orientation and type of remote imaging sensor can be used. For example, each remote imaging sensor of the array of remote imaging sensors can be a forward-looking thermal imaging system that includes a mid-wave infrared camera or a multispectral or hyperspectral camera in a nadir orientation. Because the remote imaging sensor is mounted on the remote sensing aircraft, the sensor preferably includes image stabilization capabilities. One source of such cameras is FLIR Systems, Inc., which provides several models of thermal imaging camera systems. FIG. 1 is a block diagram illustrating a remote sensing system 100 including an aircraft 110 on which an array of remote imaging sensors 120, such as an array of thermal imaging cameras, is mounted according to one embodiment. Although a single array is mounted on a single wing 115 of the aircraft 110, in other embodiments one or more additional arrays may be used, such as mounted on the opposite wing 117 of the aircraft 110. Although infrared camera systems are the typical type of remote imaging sensor, other types of sensors can be used as desired, either instead of infrared or in addition to infrared. Additional sensors can be used, for example, charge-coupled devices, color daylight optics, low light imagers, and laser rangefinders.

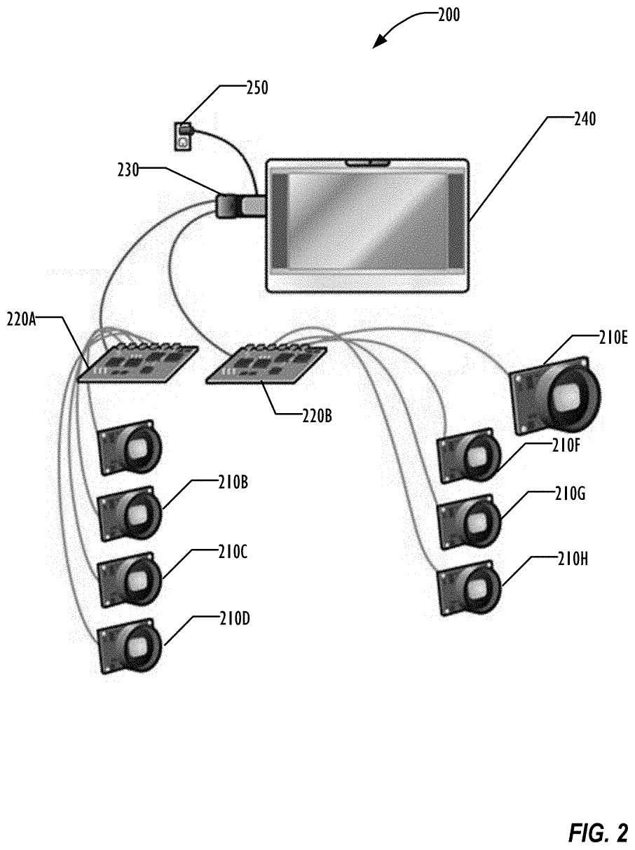

The remote imaging sensors that comprise the array of remote imaging sensors 120 include a plurality of sensor elements, including any power source required by the sensor elements and other supporting equipment such as high precision Global Positioning System (GPS), Global Navigation Satellite Systems (GNSS), or Real-Time Kinematics (RTK) units and associated antennas. FIG. 2 is a block diagram illustrating a system 200 comprising an array of eight infrared cameras 210A-H according to one embodiment, as well as supporting equipment, some of which may be mounted remotely to the array of cameras.

In this example, each of the eight infrared cameras 210A-H are connected via an IEEE 1394 connector to one of a pair of IEEE 1394 hubs 220A-B. The hubs 220A-B are then connected to an IEEE 1394 interface card 230 that provides a connection to a data collection computer 240. Although illustrated as an external card in FIG. 2, the interface card 230 may be an internal component of the computer 240 and may be implemented with an IEEE 1394 interface on the motherboard of the computer 240. The IEEE 1394 interface card 230 is connected to a power source 250 to provide power to the cameras 210A-H, hubs 220A-B, and interface card 230. Data from the cameras 210A-H can then be collected by the computer 240 for analysis, storage, etc. The power source 250 may be a battery or any other available source of electrical power. The computer 240 may share the power source 250 with the cameras 210 or have a separate power source (not shown in FIG. 2), which may be independent of the power source 250.

In this example, one of the groups of four cameras 210A-D may be mounted in an array unit on wing 115 of the aircraft 110, while the other group of cameras 210E-H may be mounted in an array unit on wing 117, the opposite wing of the aircraft 110. The number of cameras 210A-H and hubs 220A-B is illustrative and by way of example only, and any number of cameras or hubs may be used as desired, such as to fit into a desired form factor for the camera array. Although the cameras 210A-H are illustrated as connected via IEEE 1394 connectors, other types of digital or analog connectors and communication protocols can be used as desired. The computer 240 may be any type of device capable of connecting to the cameras 210A-H for collecting and processing the data. In some embodiments, the data is simply collected by the computer 240, then made available for later analysis by other computers or other devices. In other embodiments, the data collected by the computer 240 may be analyzed in real-time during flight, and the analysis used by the aircraft pilot to guide the path of aircraft 110 or to provide any other useful guidance to an operator of the sensing system 200, which may be a different person than the pilot. In some embodiments, the data collected by the computer 240 is continuously processed in situ and stored on the computer 240 or another device in the aircraft from which the data may be downloaded after the flight. In some embodiments, the data may be transmitted while in flight to a ground station via a wireless network, a satellite data network, or a mobile telephone data network such as a 4G or 5G data network. Although illustrated in FIG. 2 as all of the same type, each of the cameras 210 may be of a different type and configuration. For example, in some embodiments, some of the cameras 210 may be infrared cameras while others may be visible light spectrum cameras. Typically, the captured data includes altitude, heading, and other associated metadata in addition to the remote sensing data captured by the cameras 210.

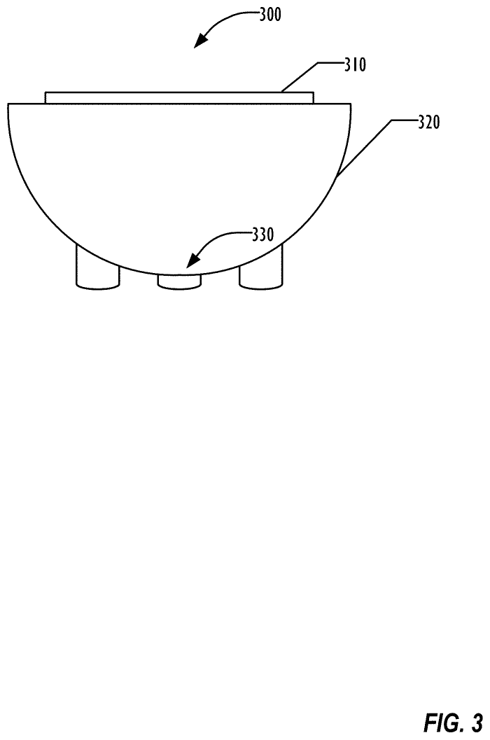

FIG. 3 is a block diagram illustrating a housing 300 within which is disposed an array of remote imaging sensors such as the system 200 illustrated in FIG. 2. The housing 300 may provide for mounting as many cameras 210 as desired, in any desired orientation. Each of the cameras 210 may be positioned with or aligned with one of an equal number of openings 330 in the housing 300. The shape of the openings 330 may be of any desired geometry to correspond to the geometry of the corresponding camera 210 which may protrude from the housing 300 as illustrated in FIG. 3 or may be entirely contained within the housing 300 to reduce drag. In some embodiments, the housing 300 provides for mounting sufficient cameras to give a 180° field of view or any other desired field of view, each camera 210 positioned within the housing so the individual fields of view of the cameras 210 is adjacent to or slightly overlaps with the field of view of other cameras 210 in the housing. In some embodiments, such as illustrated in FIG. 3, the housing 300 is a low-profile dome-shaped housing; In other embodiments, the housing 300 may have any desired shape that allows for placement of the cameras 210 in the desired position and orientation relative to each other. Because the housing 300 is mounted on an external surface of the aircraft 110, the housing 300 is preferably configured to reduce aerodynamic drag and other undesirable effects that might affect the handling of the aircraft 110.

In one embodiment, the housing 300 is mounted to a wing 115 or 117 of the aircraft 110 in a removable manner, using a mounting bracket 310 of the housing 300. In some embodiments, the housing 300 mounting bracket 310 is configured to allow rotation of the housing 300 relative to the aircraft 110, either to a predetermined orientation, configured pre-flight, or to a variable orientation that can rotate or otherwise reorient the camera array during flight as desired by an operator. This configurability of the mounting bracket 310 allows a given housing 300 and an array of cameras 210 to be configured based upon the needs of the operator. For example, an operator may choose to orient the array to aim the field of view of the cameras parallel to the flight path of the aircraft 110 (forward-looking), perpendicular to the flight path (sideways-looking), or at any other angle relative to the flight path of the aircraft 110. Openings 330 in an exterior surface 320 of the housing 300 may allow a portion of at least some of the cameras 210 to protrude through the openings 330 external to the housing 300. In some embodiments, at least some of the cameras 210 do not protrude through the openings 330 but are configured to at least approximate the exterior surface 320 of the housing 300 to reduce aerodynamic drag caused by the cameras 120. The position of the openings 330 in the housing 300 as illustrated in FIG. 3 are illustrative and by way of example only, and any desired position and arrangement of the openings 330 may be used as desired.

Although some embodiments may provide real-time communication of sensor data from the members of the array of remote imaging sensors to either an aircraft receiver system or a ground-based receiver, some embodiments provide onboard data storage that can be downloaded using wired or wireless connectivity once the towed array is landed.

Data generated by the cameras 210 may be stored in an onboard data storage contained in the housing 300, making the housing 300 and included electronics a relatively self-contained unit. In such an embodiment, the computer 240 may be disposed within the housing 300 and may be a special-purpose device for collecting and storing data from the cameras 210. Alternately, data generated in the housing 300 may be transmitted back to a system elsewhere in the plane, such as a system mounted inside the fuselage of the aircraft 110, using either a wired connection to the housing 300 or a wireless transmission technique. In such an embodiment, the computer 240 may be responsible for the collection and data transmission inside the housing 300, and another computer 240 may be mounted in the fuselage or a ground station for receiving the transmissions from the computer 240 in the housing 300. If a system mounted inside the fuselage of the aircraft 110 is provided, it may perform any or all of: (a) storing the received data; (b) analyzing the received data; or (c) transmitting the received data, any analysis results, or both to a ground receiver. The system mounted inside the fuselage of the aircraft 110 may be battery-powered or powered by an electrical system of the aircraft 110, as desired.

The data collected from the cameras 210 and any analysis data created by the computer 240 may be encrypted by the computer 240 for the security of transmission of the data from the aircraft 110 to a ground station if desired.

The aircraft 110 may be flown at various altitudes. In an embodiment in which the aircraft is flown at a low altitude between approximately 300 meters (approximately 1,000 feet) above ground level and approximately 1,800 meters (approximately 6,000 feet) the highest resolution data may be captured, but at a cost of a smaller coverage area. In other embodiments in which the aircraft 110 is flown at medium altitudes between approximately 1,800 meters (approximately 6,000 feet) to approximately 3,650 meters (approximately 12,000 feet) above ground level, the system can capture an increased cross-track area with the remote sensing cameras 210. The greater cross-track area allows for imaging multiple target areas per trip. In addition, the increased flight altitude of a medium altitude allows for a higher airspeed and more efficient aircraft operation due to reduced aerodynamic drag at medium altitudes compared to low altitudes. Furthermore, medium-altitude embodiments provide a higher margin of safety since the pilot has more time to land in the event of an aircraft malfunction. Typically, the remote sensing system onboard the aircraft will only collect data while the aircraft 110 cruises at the desired altitude range, rather than during takeoff or landing.

In some embodiments, the data may be captured by the remote sensing equipment at variable altitudes. When the aircraft 110 encounters obstacles to ideal image capture, such as a cloud layer or other aircraft, the aircraft 110 may decrease or increase altitude as needed to continue continuously capturing images of the target area. The resulting imagery may then be downsampled or upsampled as appropriate to maintain a consistent resolution and scale for the target area. compensating for the altitude variations.

By using a low- or medium altitude, relatively slow aircraft on which are mounted one or more arrays of remote imaging sensors, a larger coverage area can be covered in a single pass than in conventional techniques that mount a single remote imaging sensor with a limited field of view. Because remote imaging sensors may be small and can be mounted in the housing 300 that generates only a small amount of aerodynamic drag, a far more efficient airborne remote sensing system can be provided, reducing the cost and time required for coverage of a desired area substantially over an aircraft with a single wing- or fuselage-mounted remote imaging sensor. The coverage area can be significantly larger than any ground-based sensing technique, and requires fewer skilled operators, providing a major improvement in the field of remote sensing. The data collected by the remote sensing system can be analyzed for the detection of emissions such as hydrocarbon leaks or other types of surveillance activity.

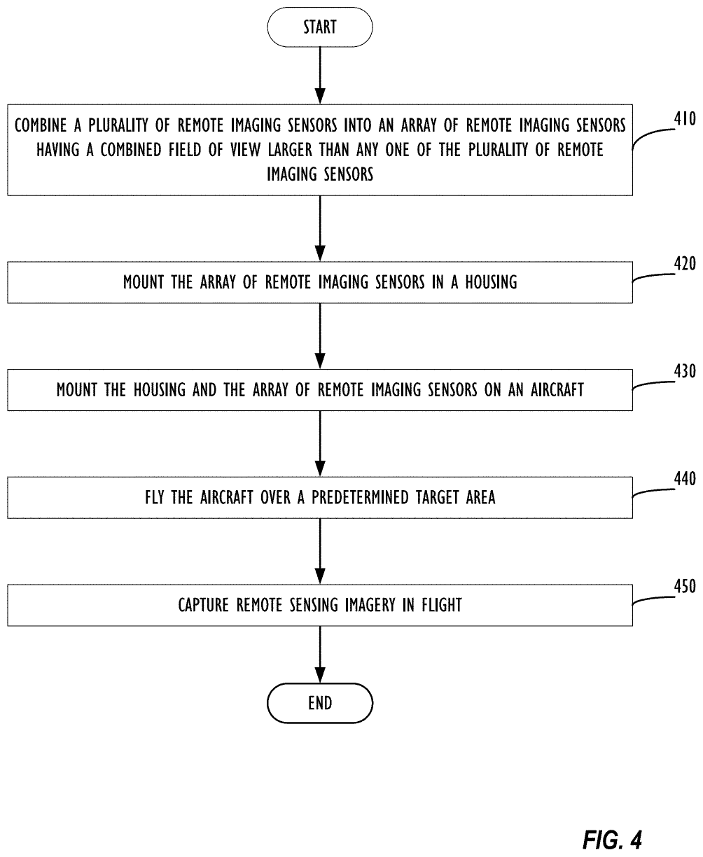

FIG. 4 is a flowchart of an example process 400. In some implementations, one or more process blocks of FIG. 4 may be performed by a remote sensing system 100.

As shown in FIG. 4, process 400 may include combining a plurality of remote imaging sensors into an array of remote imaging sensors having a combined field of view larger than any one of the plurality of remote imaging sensors (block 410). As also shown in FIG. 4, process 400 may include mounting the array of remote imaging sensors in a housing (block 420). For example, remote sensing system may mount the array of remote imaging sensors in a housing, as described above. As further shown in FIG. 4, process 400 may include mounting the housing and the array of remote imaging sensors on an aircraft (block 430). As also shown in FIG. 4, process 400 may include flying the aircraft over a predetermined target area (block 440). As further shown in FIG. 4, process 400 may include capturing remote sensing imagery in flight (block 450).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

While certain example embodiments have been described in detail and shown in the accompanying drawings, it is to be understood that such embodiments are merely illustrative of and not devised without departing from the basic scope thereof, which is determined by the claims that follow.

We claim:

1. A remote sensing system for mounting on an aircraft, comprising:
a plurality of remote imaging sensors combined as an array of remote imaging sensors for a combined larger field of view than provided by any one of the plurality of remote imaging sensors;
a housing, configured for mounting on the aircraft, wherein the array of remote imaging sensors is disposed within the housing; and
a mounting bracket, configured for attaching the housing to the aircraft.

2. The remote sensing system of claim 1, wherein the mounting bracket is removably attachable to a wing of the aircraft.

3. The remote sensing system of claim 1, wherein the mounting bracket is configured to allow rotation of the housing relative to the aircraft.

4. The remote sensing system of claim 3, wherein the mounting bracket is configured to allow rotation of the housing during a flight of the aircraft.

5. The remote sensing system of claim 1, wherein the housing comprises an exterior surface through which a remote imaging sensor of the array of remote imaging sensors protrudes while disposed within the housing.

6. The remote sensing system of claim 1, wherein the array of remote imaging sensors are disposed on a gyroscope configured so that the array of remote imaging sensors capture nadir imagery directly below the aircraft in flight at a given overlap from a previous image.

7. The remote sensing system of claim 1, wherein a sensor of the array of remote imaging sensors comprises a forward-looking thermal imaging system.

8. The remote sensing system of claim 1, wherein a sensor of the array of remote imaging sensors comprises an imaging stabilization feature.

9. The remote sensing system of claim 1, further comprising a data collection computer disposed within the aircraft.

10. The remote sensing system of claim 9, wherein the data collection computer is disposed within the housing.

11. A method of remote sensing, comprising:
combining a plurality of remote imaging sensors into an array of remote imaging sensors having a combined field of view larger than any one of the plurality of remote imaging sensors;
mounting the array of remote imaging sensors in a housing;
mounting the housing and the array of remote imaging sensors on an aircraft;
flying the aircraft over a predetermined target area; and
capturing remote sensing imagery in flight.

12. The method of remote sensing of claim 11, wherein the plurality of remote imaging sensors comprise a plurality of forward-looking thermal imaging systems.

13. The method of remote sensing of claim 11, wherein mounting the housing and the array of remote imaging sensors on the aircraft comprises mounting the array of remote imaging sensors on a gyroscope such that the array of remote imaging sensors captures nadir imagery directly below the aircraft.

14. The method of remote sensing of claim 11, further comprising:
rotating the housing on a mounting bracket during flight to a desired orientation.

15. The method of remote sensing of claim 11, further comprising:
rotating the housing on a mounting bracket to a predetermined orientation pre-flight.

16. The method of remote sensing of claim 11, further comprising:
transmitting captured remote sensing imagery in flight to a ground station.

17. The method of remote sensing of claim 11, wherein flying the aircraft over the predetermined target area comprises:
flying the aircraft at an altitude between 1800 meters and 3650 meters above ground level.

18. The method of remote sensing of claim 11, further comprising:
downsampling or upsampling the captured remote sensing imagery to compensate for altitude variations during flight of the aircraft, maintaining a consistent resolution and scale for the predetermined target area.

19. The method of remote sensing of claim 11, further comprising:
encrypting the remote sensing imagery data onboard the aircraft.

20. The method of remote sensing of claim 11, further comprising:
transmitting wirelessly the captured remote sensing imagery from the array of remote imaging sensors to a computer mounted in a fuselage of the aircraft.
